(19) United States
(12) Patent Application Publication
(10) Pub. No.: US 2002/0084068 A1
(43) Pub. Date: Jul. 4, 2002

(54) Three-way heating system valve with heat exchanger pressure regulation

(76) Inventor: Werner Hugger, Hassmersheim (DE)

Correspondence Address: Charles L. Rubow, Office of General Counsel MN12-8251, Honeywell Inc., Honeywell Plaza, Minneapolis, MN, 55408, US

(21) Appl. No.: 09/751,174

(22) Filed: Dec. 28, 2000

(51) Int. Cl. G05D 15/00

(52) U.S. Cl. 165/284

(57) ABSTRACT

A three-way heating system valve having a bypass valve between a heat source supply port and heat exchanger supply and heat source return ports for proportioning flow through the heat exchanger supply and heat source return ports, and including a differential pressure determining device between the heat exchanger supply and return ports. The pressure determining device may be a pressure relief valve and/or a pressure indicator.

### BACKGROUND OF THE INVENTION

The present invention relates generally to three-way valves, and more particularly to three-way heating system valve apparatus incorporating heat exchanger pressure differential determining structure.

Three-way valves of the type having a by-pass valve for proportioning flow between first and second outlet ports are frequently employed as mixing or distributing valves in heating, cooling and air conditioning installations. In such installations, a three-way valve is arranged between a pipe supplying a heating or cooling liquid from a boiler or cooling apparatus and a heat exchanger adapted to heat and/or cool an air conditioned space. In systems employing a plurality of heat exchangers connected in parallel to a common supply pipe, it is usual to employ regulator valves for maintaining pressure balance between the heat exchangers.

German patent document DE 195 40 580 A1 discloses a valve structure incorporating an integral regulating valve for facilitating pressure balance. The pressure differential at the output of the valve structure may then be measured, and the regulating valve set to control the heat energy provided to the heat exchanger. In order to measure the pressure differential, control plugs are provided at the output side of the valve structure to permit connection of a pressure gauge.

It obviously would be desirable to minimize the complexity of the previously described pressure differential determining arrangement. The present invention provides for integrating pressure differential measurement and outlet pressure regulation features into a three-way valve structure.

### BRIEF SUMMARY OF THE INVENTION

The invention is a three-way valve including a bypass valve for portioning fluid entering a heat source supply port between a heat source return port and a heat exchanger connected between heat exchanger supply and return ports, the three-way valve further including a pressure determining device for determining the pressure differential between the heat exchanger supply and return ports. The pressure determining device may be a pressure regulator or a differential pressure indicator. The pressure regulator may be of a design which provides a fixed pressure difference, or may be adjustable. Finally, the pressure determining device may be formed in a passageway in the valve structure between the heat exchanger supply and return ports.

Accordingly, the invention provides for an improved three-way valve into which differential pressure regulation and/or indication are integrated to achieve simplified construction and installation.

### BRIEF DESCRIPTION OF THE DRAWINGS

FIG. 1 is a sectional view of a three-way valve of prior art design;

FIG. 2 is a sectional view the prior art valve of FIG. 1 taken along lines 2-2, showing details of pressure control apparatus incorporated into the valve structure;

FIG. 3 is a sectional view of a first embodiment of a three-way valve according to the present invention;

FIG. 4 is a sectional view of a second embodiment of a three-way valve according to the present invention; and

FIG. 5 is a sectional view of a third embodiment of a three-way valve according to the present invention.

### DETAILED DESCRIPTION OF THE INVENTION

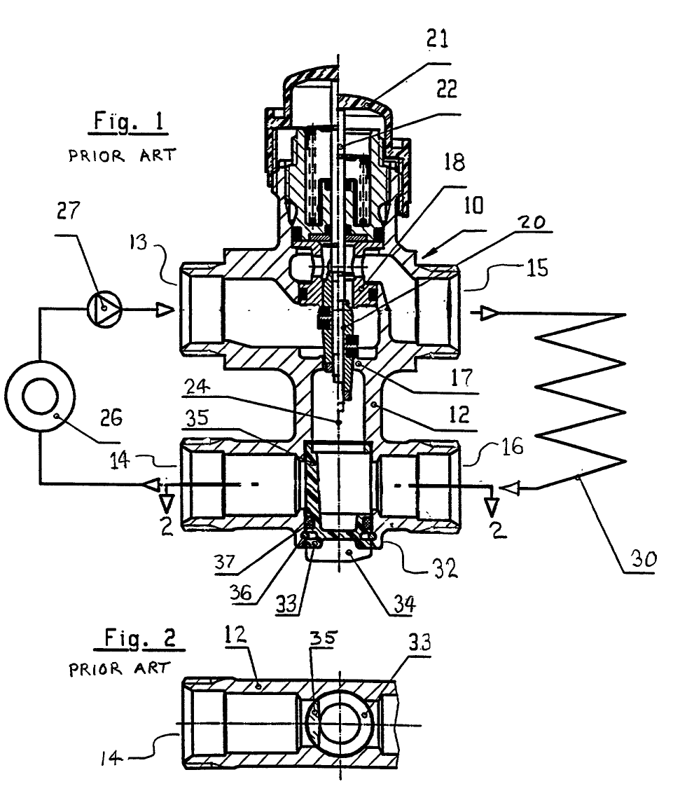

In FIG. 1, reference numeral 10 identifies a three-way mixing valve of prior art design including a housing 12 of “H” shaped configuration. Housing 12 defines an inlet port 13, first and second outlet ports 14 and 15, and a return port 16. Inlet port 13 is connected to first outlet port 14 by means of a passageway containing a first valve seat 17, and to second outlet port 15 through a passageway containing a second valve seat 18. Valve seats 17 and 18 cooperate with a closure body 20 whose position relative to the valve seats is determined by an actuator 21 connected to closure body 20 through a valve stem 22. Valve seats 17 and 18 are concentric with and spaced along an axis 24 with which closure body 20 and valve stem 22 are aligned. Actuator 21 is shown as a knob which is rotatable about axis 24, and which cooperates with housing 12 such that when rotated relative to the housing, it causes closure body 20 to be differentially positioned between valve seats 17 and 18 to cause fluid entering inlet port 13 to be differentially proportioned between outlet ports 14 and 15.

As shown in FIG. 1, mixing valve 10 is connected in a heating system wherein a fluid (typically water) is pumped from a heat source 26, such as a boiler, into inlet port 13 by means of a pump 27, and water leaving outlet port 14 is returned to heat source 26. A heat exchanger 30 associated with a space in which the air is to be temperature controlled is connected between outlet port 15 and return port 16. In the following description, ports 13 and 14 are sometimes referred to as heat source supply and return ports, respectively, and ports 15 and 16 are sometimes referred to as heat exchanger supply and return ports, respectively.

As shown in FIG. 1, housing 12 includes an extension 32 along axis 24 into which is fitted a regulating insert 33, which is rotatable about axis 24, and is configured to provide variable closure of the passageway leading to outlet port 14, thereby controlling the pressure in heat exchanger 30. In particular, regulating insert 33 includes a circular plug on which is formed a knob 34 for facilitating rotation of the plug. Also formed on the plug, as can best be seen in FIG. 2, is a shutter portion 35 offset from axis 24 and configured to cover a variable portion of the passageway leading to outlet port 14, depending on the rotational position of insert 33 relative to housing 12.

Regulating insert 33 is shown secured in housing 12 by means of a snap ring 36 which cooperates with corresponding grooves in the housing and regulating insert. An O-ring 37 provides a seal between housing 12 and regulating insert 33. Regulating insert 33 provides for adjusting the flow through heat exchanger 30 in order to control the heat energy delivered by the heat exchanger.

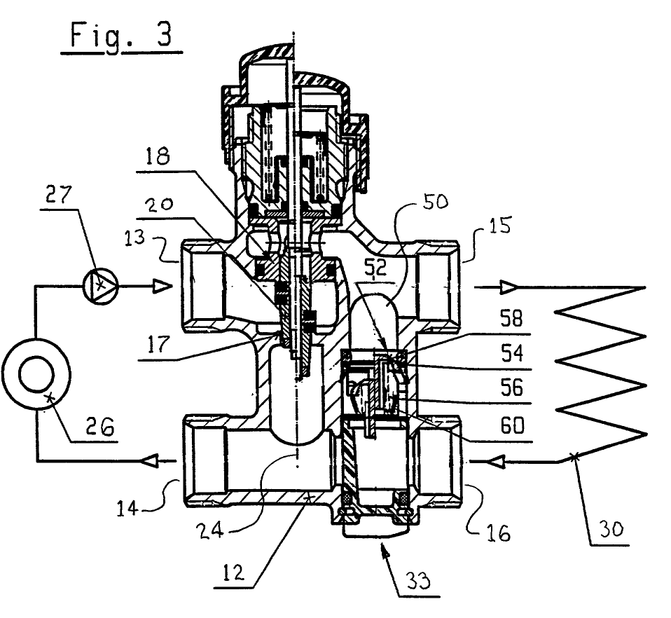

Except as will be described hereinafter, the embodiments of the present invention shown in FIGS. 3-5 are identical to the prior art embodiment of FIGS. 1 and 2. Identical elements in all Figures are identified by the same reference numerals.

As shown in FIG. 3, housing 12 also defines a passageway 50 parallel with, but offset from axis 24, passageway 50 extending between the passageways leading to outlet port 15 and return port 16. Within passageway 50 is a differential pressure relief valve 52 comprising a valve seat 54 formed in housing 12, against which a spring 56 biases a closure body 58, the spring being compressed between the closure body and a fixed spring seat 60. As in the system of FIG. 1, flow through heat exchanger 30 may be adjusted by regulating insert 33, thereby controlling the heat energy provided by the heat exchanger.

Pressure relief valve 52 provides for a fixed pressure differential across heat exchanger 30, and serves to assure that the pressure differential determined by spring 56 is produced across heat exchanger 30 between outlet port 15 and return port 16. The heat energy supplied to heat exchanger 30 can then be set by actuator knob 21, and will remain substantially stable for any particular setting thereof.

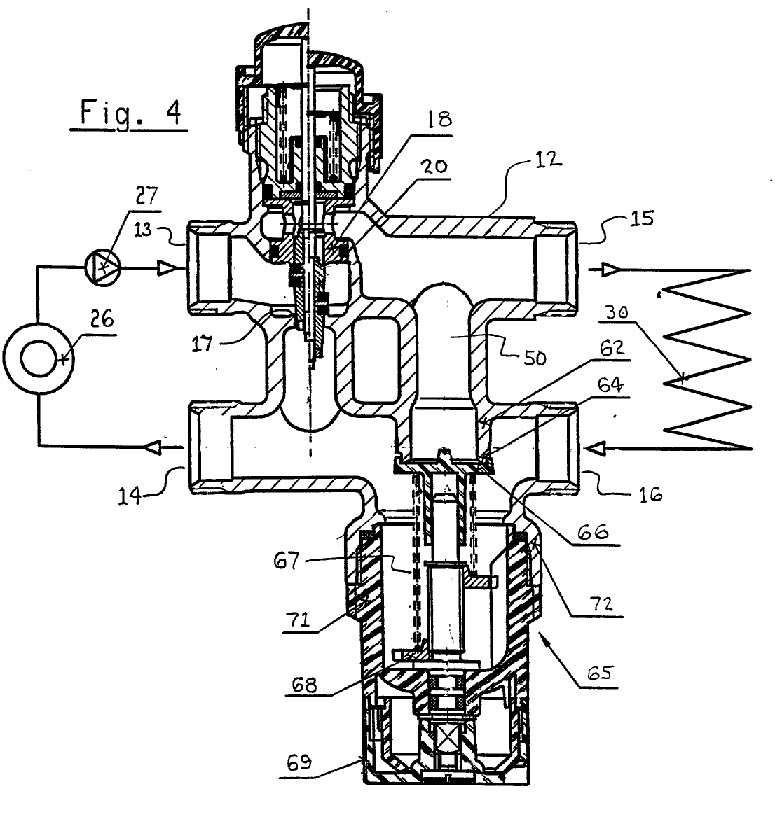

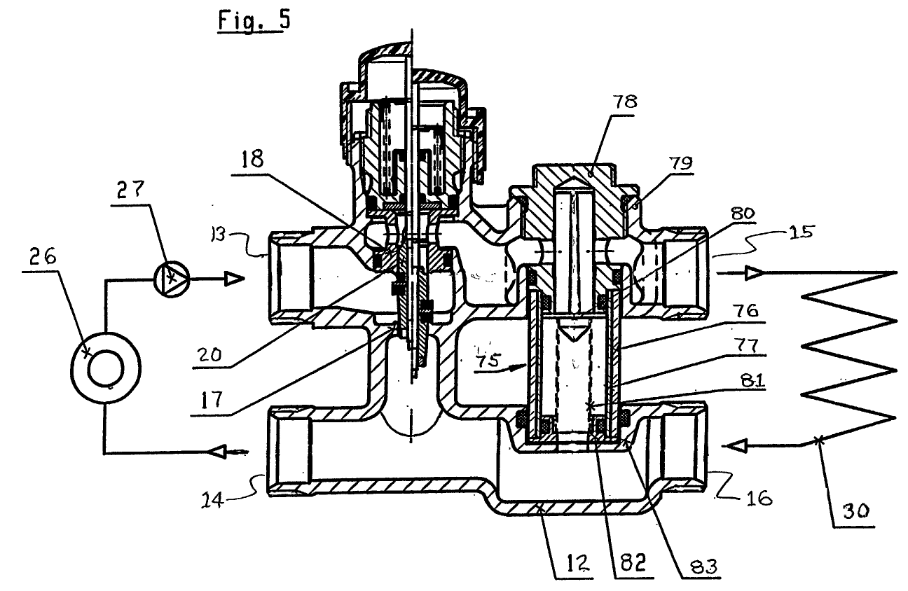

A second embodiment of the invention shown in FIG. 4 also incorporates integral passageway 50 in parallel with the passageway containing valve seat 17 between inlet port 13 and outlet port 14. The portion of housing 12 defining passageway 50 includes a tubular extension 62 which protrudes into a passageway between outlet port 14 and return port 16, and which terminates in a valve seat 64 of a differential pressure relief valve 65 of the type disclosed in German utility model 92 11 659.

Valve 65 is shown having a closure disk 66 which is biased against valve seat 64 by a spring 67. Spring 67 is arranged to be variably compressed between closure disk 66 and an adjustable spring seat 68 whose position can be varied by a knob 69 which controls the axial position of the spring seat to provide for an adjustable pressure differential across heat exchanger 30. The particular design shown for this arrangement includes a bonnet 71 having an external thread which cooperates with an internal thread of an external tubular extension 72 of housing 12 aligned with extension 62.

The third embodiment of the invention shown in FIG. 5 incorporates a differential pressure indicating device 75 of a design also disclosed in German utility model 92 11 659. Pressure indicating device 75 is in the form of a transparent tubular assembly which provides a the passageway parallel to the passageway containing valve seat 17 between inlet port 13 and outlet port 14. The transparent tubular assembly, which forms a sight glass, is made up of an outer glass tube 76 and an inner plastic tube 77. As shown, the transparent tubular assembly at its opposite ends, is sealed to the portions of housing 12 defining outlet port 15 and return port 16 by means of O-rings, and is retained in the housing by means of an insert 78 having an external thread which cooperates with an internal thread in a boss 79 formed in the housing. A piston 80 within the transparent tubular assembly is biased upwardly by means of a spring 81 compressed between the piston and a fixed spring seat 82 mounted in a receiving cup 83 formed in the portion of housing 12 that defines return port 16.

Obviously it would be possible to combine the differential pressure relief valve shown in FIG. 4 and the differential pressure indicating device shown in FIG. 5 in a single integrated structured, which combination is known from German utility patent 92 11 659. European patent 0 455 678 discloses an alternative form of a differential pressure indicating device which may be substituted for the indicating device shown in FIG. 5, and which may also be integrated into a valve structure with the differential pressure relief valve shown in FIG. 4.

Finally, although not shown in FIGS. 4 and 5, a regulating insert such as insert 33 may also be incorporated into these improved three-way valve embodiments.

1. An improved three-way valve of the type having a housing forming heat source supply and return ports and heat exchanger supply and return ports, the housing further defining a bypass valve for permitting fluid flow between the heat source supply port and the heat exchanger supply and heat source return ports, the fluid flow being differentially proportioned between the heat exchanger supply and heat source return ports, wherein the improvement comprises:
a differential pressure determining device at least partially formed in the housing operably connected between the heat exchanger supply and return ports.

2. The improved three-way valve of claim 1 wherein said differential pressure determining device is a differential pressure relief valve.

3. The improved three-way valve of claim 2 wherein said differential pressure relief valve is of a design which produces a fixed fluid pressure differential between the heat exchanger supply and return ports.

4. The improved three-way valve of claim 2 wherein said differential pressure relief valve is of a design which produces an adjustable pressure difference between the heat exchanger supply and return ports.

5. The improved three-way valve of claim 2 wherein said differential pressure relief valve comprises a passageway between the heat exchanger supply and return ports, the passageway containing a valve seat against which a closure body is biased by a spring.

6. The improved three-way valve of claim 5 wherein said differential pressure relief valve includes a mechanism for adjusting the compression of said spring.

7. The improved three-way valve of claim 1 wherein said differential pressure determining device is a differential pressure indicator.

8. The improved three-way valve of claim 7 wherein said differential pressure indicator comprises a passageway between the heat exchanger supply and return ports, the passageway having a sight glass therein containing a piston displaceable against a biasing spring.

9. The improved three-way valve of claim 1 wherein said pressure determining device is a combination differential pressure relief valve and pressure indicator.

10. The improved three-way valve of claim 2 including a pressure regulating fluid connection between the heat source and heat exchanger return ports.
